(19) United States
(12) Patent Application Publication
(10) Pub. No.: US 2009/0317632 A1
(43) Pub. Date: Dec. 24, 2009

(54) METHOD FOR THE PRODUCTION OF MATERIAL BOARDS AND MATERIAL BOARD

(75) Inventor: Herbert Ruhdorfer, Salzburg (AT)

Correspondence Address: GREENBLUM & BERNSTEIN, P.L.C., 1950 ROLAND CLARKE PLACE, RESTON, VA, 20191, US

(73) Assignee: INTERGLARION LIMITED, Nikosia Cyprus

(21) Appl. No.: 12/374,251

(22) PCT Filed: Jul. 16, 2007
(86) PCT No.: PCT/EP2007/006296

§ 371 Date: Jan. 16, 2009

(30) Foreign Application Priority Data
Jul. 17, 2006 (DE) 10 2006 032 947.3

(51) Int. Cl. B32B 21/08; B32B 37/12

(52) U.S. Cl. 428/340; 156/62.2; 428/511

(57) ABSTRACT

A method for the production of material plates made of chip- or fiber material, in particular of chipboard, LDF board, MDF board, HDF board, and OSB board, encompasses the following: providing dried chip- or fiber material, plasma-treating the dried chip- or fiber material, applying glue to the plasma treated chip- or fiber material, and compressing the chip- or fiber material that has glue applied into material plates. The invention also relates to such a material plate.

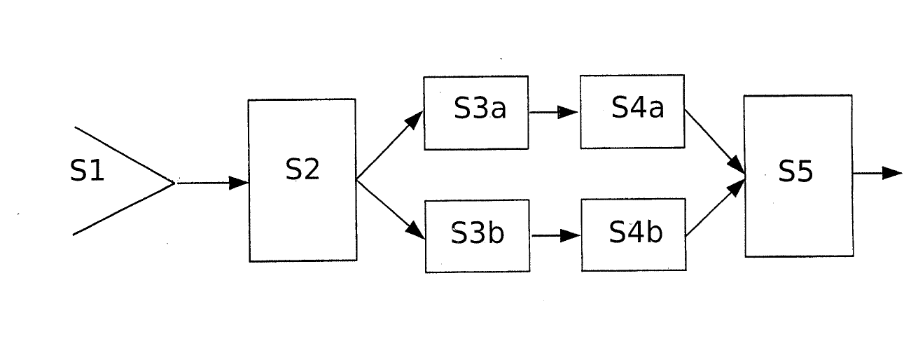

### BACKGROUND OF THE INVENTION

1. Field of the Invention

The invention relates to a method for the production of material boards of chip material or fibrous material, in particular of chipboards, LDF boards (low density fiberboard), MDF boards (medium density fiberboard), HDF boards (high density fiberboard) and OSB boards (oriented strandboard). The invention also relates to such a material board.

2. Background Information

With a known general method for producing chipboards, the wood chips provided, for example, by cutting wood, are first dried and subsequently sorted by chip size, for example, into two classes, namely the larger center-layer chips and the smaller cover-layer chips, and either stored separately or fed directly to further processing. The chips are usually then glued and scattered on a conveyor belt such that the cover-layer chips are arranged on the outside and the center-layer chips are arranged in the center of the unpressed bed of chips, which is subsequently pressed to form boards in a continuous process by means of a belt press.

The process is also analogous in the production of fiberboards, for example MDF boards or HDF boards, wherein, however, no subdivision into cover-layer chips and center-layer chips is carried out, although the fibers are generally formed of a mixture of predetermined proportions of predetermined fiber types.

Conventionally, approximately 90 kg liquid glue is required per cubic meter volume of the material board to obtain the desired mechanical strength properties of the material board, for example, with chipboards, which corresponds to approximately 60 kg solid glue after hardening. Glue quantities of this type are an important cost factor in the production of material boards.

### SUMMARY OF THE INVENTION

In this context, the present invention provides a method for the production of material boards of chip material or fibrous material that renders possible a more cost-effective production compared to the conventional methods.

To this end, the present invention provides a method of the general type, which comprises the following: providing dried chip material or fibrous material; plasma-treating the dried chip material or fibrous material applying glue to the plasma-treated chip material or fibrous material compressing the glued chip material or fibrous material to form material boards.

The decisive difference between the method according to the invention and the known method is therefore that according to the invention the dried chip material or fibrous material is subjected to an additional plasma treatment before the application of glue. With a plasma treatment of this type, a process gas is ionized in the space between two electrodes acted on with high voltage. The dried chips or fibers are exposed to the process gas plasma thus formed, whether by allowing them to fall through the plasma or by moving them through the plasma in a loose bed, for example on a haulway. In any case, depending on their kinetic energy, the ions penetrate into the surface of the chips or fibers, for example, up to 10 μm deep. The physical and chemical changes in the chip surface or fiber surface thus produced have not yet been explained. However, it is a scientifically proven fact that a treatment of this type produces an improved adhesion of the surface so that, as desired, a glue layer applied adheres better to a chip surface or fiber surface thus treated.

Although surface properties being influenced by a plasma treatment has been quite generally known, that the adhesion of glue to the plasma-treated surface of chips and fibers could be influenced and, in addition, could be improved thereby has not necessarily been expected. Furthermore, that the improvement in adhesion surprisingly achieved would also be retained over a period relevant for the service life of the material boards and the products made from these material boards was not to be expected. Finally, that the improved adhesion would achieve and retain a scope such that the savings in terms of the glue used in the production of the material boards would justify the investment expenses and operating expenses for a plasma treatment plant could also not be expected. It is the inventors' achievement that they overcame all of these doubts.

As already indicated, it is the inventors' achievement to have discovered that the advantage surprisingly results through the additional and cost-intensive plasma treatment, which at first appears unnecessary, in the further processing of the chip material or fibrous material, that in the subsequent application of glue to the plasma-treated chips or fibers a much smaller amount of glue is necessary than with the conventional method, and, despite the smaller amount of glue used, the material boards produced according to the method according to the invention nevertheless meet the mechanical requirements under the industrial standards applicable to the individual material boards. Because the savings in the amount of glue to be used per cubic meter of material board material by far outweigh the investment costs to be assigned to the production of this cubic meter of material board material, the material boards can be produced more cost-effectively according to the method according to the invention.

In particular, the inventors have established that no more than 75 kg, and even no more than 67 kg, liquid glue needs to be used per cubic meter material board, which after hardening corresponds to a quantity of no more than 50 kg, and, in a particular embodiment, no more than 45 kg, solid glue. This corresponds to savings in terms of glue of more than 15%, and, in a particular embodiment, more than 25%, compared to conventional methods. With a particular embodiment of the present invention, savings in terms of glue of even approx. 30% are achieved, which corresponds to the use of 63 kg liquid glue or approx. 42 kg solid glue. The production costs of the material boards produced with the method according to the invention can be substantially reduced through such high savings in terms of glue.

The plasma treatment of the dried chip material or fibrous material according to the invention can be realized, for example, in that respectively a predetermined quantity of chip material or fibrous material is exposed to a low-pressure plasma in a low-pressure chamber in a batch process. It can be ensured through this that the chip material or fibrous material is plasma-treated uniformly, i.e., as far as possible on all surfaces of all of the individual chips and fibers, so that subsequently the surface properties are homogenous over the entire chip material or fibrous material. However, alternatively, it can also be moved in a continuous process past a nozzle of a device for plasma under atmospheric pressure.

In both method alternatives the process gas used in the plasma treatment can comprise oxygen and/or nitrogen and/or argon as main component. In the use of a low-pressure plasma for the plasma treatment, for example, air can thus be used as process gas, whereby a complex evacuation of the low-pressure chamber before the introduction of the process gas can be prevented, and the pressure in the low-pressure chamber after charging needs to be reduced only to the pressure necessary for the plasma treatment (in the order of magnitude of 0.5 to 5 mbar).

In further development of the invention, the process gas used in the plasma treatment can comprise fluorine as an additional component. It has been particularly established according to the invention that the swelling behavior of the chips or fibers under the effect of moisture can be influenced advantageously through the addition of fluorine to the process gas, i.e., the swelling of the chips or fibers under the effect of moisture can be reduced. This leads to a much increased stability of the material boards produced in this manner with respect to the effect of moisture. Conventionally, a paraffin emulsion is added in the production of chipboards to reduce the undesirable swelling. Through the plasma treatment with a process gas containing fluorine, the use of paraffin emulsion can be omitted completely or at least in part. This results in further cost savings.

The duration of the plasma treatment of the chip material or fibrous material can, in a particular embodiment, be 1 to 10 minutes. Surface properties of sufficient quality of the chips or fibers can thus be obtained with a throughput of chip material or fibrous material, that is as high as possible.

In a further development of the invention, it is proposed for the chip material or fibrous material to be present before the plasma treatment in several groups that differ according to the size of the individual chips and fibers. Furthermore, different groups can respectively be separately plasma-treated and subsequently glued before they are reunited for compression to form a material board. It can hereby be ensured, for example in the production of a chipboard, that optimal operating parameters can be used in each case in the plasma treatment for the smaller cover-layer chips as well as for the larger center-layer chips so that the savings in terms of glue that can be obtained can be maximized.

In a particular embodiment, no more than 30 minutes or, in a more particular embodiment, no more than 1 minute, may elapse between the plasma treatment process phase and the phase of applying glue to the chip material or fibrous material in order to ensure that the surface properties of the chip material or fibrous material improved by the plasma treatment do not deteriorate again due to excessively long storage times.

The chip material or fibrous material used according to the invention can comprise wood chips and/or wood fibers and/or hemp fibers and/or straw fibers, so that not only different types of wood material boards such as, for example, chipboards, LDF boards, MDF boards, HDF boards and OSB boards, but also material boards that contain hemp fibers and/or straw fibers can be produced.

For example, urea formaldehyde resin or urea melamine-formaldehyde resin or phenol formaldehyde resin, with a solids content of 40 to 80%, according to a particular embodiment, can be used for the glue application.

In a further development of the present invention, it can furthermore be provided that other substances apart from fluorine can also be added to the process gas in the plasma treatment, for example, in order to obtain material boards with fire-retardant properties and/or with antibacterial properties and/or with reduced susceptibility to mold formation.

The invention furthermore relates to a material board of chip material or fibrous material, in particular chipboard, LDF board, MDF board, HDF board and OSB board, which does not comprise more than 50 kg or, in a particular embodiment, not more than 45 kg solid glue per cubic meter of material board. The chip material or fibrous material can thereby comprise wood chips and/or wood fibers and/or hemp fibers and/or straw fibers. Furthermore, the glue can comprise urea formaldehyde resin or urea melamine-formaldehyde resin or phenol formaldehyde resin, with a solids content, according to a particular embodiment, of 40 to 80%.

### BRIEF DESCRIPTION OF THE DRAWING

An embodiment of the present invention is described below purely by way of example based on the attached drawing, wherein:

The single view is a block diagram for the diagrammatic explanation of a method according to the invention for producing a chipboard.

### DETAILED DESCRIPTION OF THE INVENTION

An exemplary embodiment of the present invention is shown diagrammatically in the single drawing FIGURE, in the process phase S1, material such as first round timber, chopped good, wood remnants and the like are fed to a conventional cutting installation.

In the process phase S2, the fed wood is then processed to form chips with the aid of the cutting installation, these chips being dried in a conventional drier installation, for example in a drum drier, up to a residual moisture of approx. 2%, and subsequently screened, so that smaller chips, which will later serve as cover-layer chips of the chipboard, can be separated from larger chips, which will later serve as center-layer chips of the chipboard.

The method according to the invention does not differ from conventional production methods for material boards of chip material or fibrous material in these two process phases, and it is completely immaterial for the method according to the invention precisely how the provision of dried chip material or fibrous material is carried out. It is therefore also conceivable that the cutting and drying does not take place directly on site, but already dried chip material or fibrous material is supplied from a storage facility.

In process phase S3a, the cover-layer chips are placed in a low-pressure chamber, which then is pumped down to an operating pressure of approx. 0.5 to 5 mbar. As soon as the operating pressure has been reached, a plasma is ignited in the low-pressure chamber, wherein in this case the air remaining in the low-pressure chamber is used as process gas. It is also possible, however, to use other process gases, such as, for example, argon, and/or to add one or more additives such as, for example, fluorine, to the respectively used process gas. The plasma treatment during which the cover-layer chips are exposed to the plasma, lasts approx. between 1 and 10 minutes.

In process phase S3b, the center-layer chips are likewise plasma-treated analogously to the process phase S3a. The separate plasma treatment of the cover-layer chips and the center-layer chips has the advantage hereby that, on the one hand, process parameters such as, for example, operating pressure, treatment duration and composition and/or concentration of the process gas, can be individually adjusted to the respective type of chips and that, on the other hand, different additives can be added to the respective process gas individually for each type of chips in suitable composition and concentration.

Following process phase S3a or phase S3b, in phase S4a or phase S4b, the cover-layer chips and the center-layer chips are respectively glued separately. Urea formaldehyde resin, urea melamine-formaldehyde resin or phenol formaldehyde resin is used hereby as a gluing agent, as also with conventional production methods for chipboards.

Because the wettability of the chip surface is improved through the plasma treatment of the chips according to the invention, approx. 30% less gluing agent can be used hereby than with conventional production methods for chipboards, without the mechanical strength properties of the finished chipboard suffering as a result. While with conventional methods approx. 90 kg liquid gluing agent per cubic meter chipboard is needed in order to produce chipboards with the mechanical strength properties required by the relevant industrial standards, the method according to the invention ideally manages with only approx. 63 kg liquid gluing agent per cubic meter material board. These significant cost savings thus already justify the additional costs and the effort of the additional process phase of the plasma treatment in the method according to the invention for producing material boards.

Furthermore, through suitable additives in the process gas during the plasma treatment other properties of the chips can also be advantageously influenced. An addition of fluorine, for example, produces an advantageous influencing of the swelling behavior of the chips so that the otherwise customary addition of paraffin emulsion in the production of the chipboard to reduce the swelling behavior of the finished board can be omitted completely or in part, and thus additional cost savings can be achieved.

After the application of glue in the process phase S5, the cover-layer chips and the center-layer chips are scattered together on a conveyor belt such that the surfaces of the layer formed comprise unpressed, glued chips of cover-layer chips, and center-layer chips are arranged in the center of this layer. The chips are finally compressed, for example, in a conventional belt press and heated in order to form a chipboard.

It is hereby completely immaterial again for the method according to the invention how the phases of arranging the chips and compressing, which are known and conventional per se in the production of material boards, are carried out in detail. Thus any possible layer method and pressing method of the glued chips is conceivable here that is conventionally used in the production of material boards of chip material or fibrous material.

1-13. (canceled)

14. A method for the production of material boards of chip material or fibrous material, including chipboards, LDF board, MDF boards, HDF boards, and OSB boards, said method comprising:
providing dried chip material or fibrous material;
plasma-treating the dried chip material or the fibrous material, said plasma-treating comprises using a process gas comprising fluorine as an additional component;
applying glue to the plasma-treated chip material or the plasma-treated fibrous material; and
compressing the glued chip material or the glued fibrous material to form material boards.

15. A method according to claim 14, wherein:
said applying glue comprises applying no more than 75 kg of liquid glue per cubic meter of material board.

16. A method according to claim 14, wherein:
said applying glue comprises applying no more than 67 kg of liquid glue per cubic meter of material board.

17. A method according to claim 14, wherein:
said applying glue comprises applying no more than 50 kg of solid glue per cubic meter of material board.

18. A method according to claim 14, wherein:
said applying glue comprises applying no more than 45 kg of solid glue per cubic meter of material board.

19. A method according to claim 14, wherein:
said plasma treating comprises using, as a main component of the process gas, at least one of the following: oxygen, nitrogen, argon.

20. A method according to claim 14, wherein:
said plasma treating comprises low-pressure plasma treating a predetermined quantity of the dried chip material or the fibrous material in a batch process.

21. A method according to claim 20, wherein:
the plasma-treating of the dried chip material or fibrous material has a duration of 1 to 10 minutes.

22. A method according to claim 14, wherein:
the chip material or fibrous material is present before the plasma-treating in several groups that differ according to size of individual chips and fibers; and
the groups are respectively separately plasma-treated and subsequently glued before being assembled for said compressing to form a material board.

23. A method according to claim 14, wherein:
no more than 30 minutes elapse between the plasma-treating and the applying glue the chip material or the fibrous material.

24. A method according to claim 14, wherein:
no more than 1 minute elapses between the plasma-treating and the applying glue the chip material or the fibrous material.

25. A method according to claim 14, wherein:
the chip material or the fibrous material comprises at least one of the following: wood chips, wood fibers, hemp fibers, straw fibers.

26. A method according to claim 14, wherein:
one of the following is used for said applying glue to the plasma-treated chip material or the plasma-treated fibrous material: urea formaldehyde resin, urea melamine-formaldehyde resin, phenol formaldehyde resin.

26. A method according to claim 14, wherein:
one of the following, with a solids content of 40% to 80%, is used for said applying glue to the plasma-treated chip material or the plasma-treated fibrous material: urea formaldehyde resin, urea melamine-formaldehyde resin, phenol formaldehyde resin.

27. A material board of chip material or fibrous material, in the form of a chipboard, LDF board, MDF board, HDF board, or OSB board, made by the method of claim 14, comprising no more than 50 kg solid glue per cubic meter of material board.

28. A material board according to claim 27, comprising:
no more than 45 kg solid glue per cubic meter of material board.

29. A material board according to claim 27, wherein:
the chip material or the fibrous material comprises at least one of the following: wood chips, wood fibers, hemp fibers, straw fibers.

30. A material board according to claim 27, wherein:
the glue comprises one of the following: urea formaldehyde resin, urea melamine-formaldehyde resin, phenol formaldehyde resin.

31. A material board according to claim 27, wherein:
the glue, having a solids content of 40% to 80%, comprises one of the following: urea formaldehyde resin, urea melamine-formaldehyde resin, phenol formaldehyde resin.
